(19) United States
(12) Patent Application Publication
(10) Pub. No.: US 2026/0249595 A1
(43) Pub. Date: Aug. 27, 2026

(54) POLYOLEFINIC PACKAGING FILM

(71) Applicant: RKW SE, Mannheim (DE)

(72) Inventors: Leonhard Maier, Babensham (DE); Christina SALOMON, Kageroed (SE)

(73) Assignee: RKW SE, Mannheim (DE)

(21) Appl. No.: 18/993,059

(22) PCT Filed: Jul. 12, 2023
(86) PCT No.: PCT/EP2023/069366

§ 371 Date: Jan. 10, 2025

(30) Foreign Application Priority Data
Jul. 13, 2022 (DE) 10 2022 117 441.7

(51) Int. Cl. B32B 27/08; B32B 27/32; B32B 37/15; B32B 38/00

(52) U.S. Cl. CPC B32B 27/08; B32B 27/32; B32B 37/153; B32B 38/0012; B32B 38/145; B32B 2038/0028; B32B 2250/05; B32B 2264/104; B32B 2264/307; B32B 2305/30; B32B 2307/516; B32B 2307/72; B32B 2307/7244; B32B 2307/7246; B32B 2323/043; B32B 2323/046; B32B 2439/70

(57) ABSTRACT

A polyolefinic packaging film (1) for grease-containing foodstuffs with at least one blocking layer (3), a functional layer (5) and a filled layer (2, 4, 6). The packaging film (1) is stretched to produce a proportion of cavities, to adjust the overall density of the packaging film (1) for a recycling process to a value of less than 0.99 g/cm³.

### CROSS REFERENCE TO RELATED APPLICATIONS

This application is a 371 National Phase of PCT/EP2023/069366, filed Jul. 12, 2023, which claims priority from German Patent Application No 10 2022 117 441.7, filed Jul. 13, 2022, both of which are incorporated herein by reference as if fully set forth.

### TECHNICAL FIELD

The invention relates to a polyolefinic packaging film for grease-containing foodstuffs with at least one blocking layer, one functional layer and one filled layer.

### BACKGROUND

The classic packaging materials for food, especially for butter and cheese, are based either on satin-finished paper or usually an aluminum composite film that is wax-laminated on the butter side and carries real parchment.

These packaging materials have to meet a number of requirements, such as good appearance, printability and barrier properties against grease and light, as well as oxygen and water vapor permeability to a certain extent. In addition, the packaged food should not be affected by the packaging material itself during long storage periods. Finally, the packaging material is required to have high mechanical strength combined with good foldability.

EP 0 445 565 A2 describes a packaging material for solid, grease-containing products such as butter. The packaging material consists of an aluminium foil which has a grease-resistant and grease-repellent protective coating on one side and a glassine layer laminated on the other side by means of an ethylene copolymer.

EP 2 314 450 A1 discloses a packaging film for butter and cheese consisting of a laminate provided on an outer side with a coated aluminum foil, the aluminum foil having a thickness of 5-10 μm and being laminated with a paper-like HDPE film having a thickness of 20-50 μm. The packaging film retains sharp and permanent creases after folding, for example by closing a conventional butter package.

DE 10 2010 053 115 A1 describes a pack consisting of paper, film, tin foil or other moldable, film-like packaging material that completely packs pasty goods on the outside by initially folding the tube and later folding the end faces.

Aluminum-based food packaging is difficult to recycle as it is not pure aluminum, but is combined with many different materials that cannot be completely separated from each other. In addition, aluminum loses quality and purity with each recycling step and requires large amounts of energy to recycle.

Filled polyolefin packaging films, especially polyethylene-based films, are a more environmentally friendly alternative to conventional packaging films with effective food protection and good printability for an attractive appearance. At the same time, they have a paper-like appearance and a pleasant feel.

These packaging films are made from recyclable polyolefins to which natural minerals are added. With up to or over 50% mineral content, the packaging films provide an effective barrier against light, oxygen and water vapor and are also grease-resistant. In addition, they have significantly improved tear and fold resistance compared to more complex laminate solutions such as PE/paper.

Pure polyolefin waste products based on polyethylene and/or polypropylene can be remelted directly into new products or processed into regranulate. This recycled plastic is increasingly developing into a technically and economically convincing alternative to virgin material, which means that fossil raw materials can be saved.

However, separating the valuable plastic waste in the recycling process of the float-sink method has proven to be problematic. By adding water, the light polyolefins should float and be skimmed off. By using mineral fillers to reduce the proportion of fossil raw materials and to achieve the desired mechanical properties and printability, the filled polyolefin packaging films no longer float or do not float well due to their density of more than 1.00 g/cm³.

Mechanical recyclability is currently defined in such a way that polyolefin products must be recyclable for specific materials and sortable using state-of-the-art processes in order to be labeled as “recyclable”. Mineral-filled polyolefin packaging films can therefore not be fed into the recycling loop as desired. However, many consumers of greasy foods expect the packaging films to be recycled. There are now also legal requirements that stipulate a minimum level of packaging recycling.

### SUMMARY

The object of the invention is to provide a polyolefin-based packaging film for greasy foods which is optimized for the float-sink process within a recycling process. The packaging film should have all the advantages of known polyolefin films for greasy foods. The food packaging should be greaseproof and lightproof, it should be easy to fold, have excellent mechanical properties and be advantageously printable.

According to the invention, this task is ensured by a polyolefinic packaging film for grease-containing foodstuffs, a method and a use according to the subsidiary main claims. Preferred variants can be found in the subclaims, the description, the embodiment example and the drawings.

According to the invention, the packaging film is stretched to produce a proportion of cavities for adjusting the overall density of the packaging film for a recycling process to a value of less than 0.99 g/cm³.

In abstract terms, a cavity is an empty or gas-filled space inside something solid. The space is therefore surrounded by a solid boundary that separates the space from the outside. In the case of a polyolefinic film, the space is delimited from the outside by polymeric material.

The cavities do not have to be completely closed and can also be interconnected, for example.

Preferably, a cavity and/or a plurality of cavities and/or all cavities of the film or individual layers of the film can be designed in the form of vacuoles.

Preferably, the volume fraction of the cavities in the or in each filled layer is more than 15%, preferably more than 25%, in particular more than 30% and/or less than 60%, preferably less than 50%, in particular less than 45%. This results in a film which, despite a high mineral content, has a total density of less than 0.99 g/cm³ and can therefore float within a recycling process using the float-sink method.

Ideally, the overall density of the packaging film is less than 0.97 g/cm³, preferably less than 0.95 g/cm³, in particular less than 0.93 g/cm³ and/or more than 0.70 g/cm³, in particular more than 0.75 g/cm³, in particular more than 0.80 g/cm³. This significantly increases the speed of floating in the float-sink process, which can optimize the economic efficiency of the recycling process.

To create cavities or hollow spaces, the packaging film is preferably stretched monoaxially in the machine direction by more than a factor of 2.0, preferably by more than a factor of 3.0, in particular by more than a factor of 4.0 and/or stretched by less than a factor of 7.0, preferably by less than a factor of 6.5, in particular by less than a factor of 6.0. The fillers cause cavities to form in the filled layers when the packaging film is stretched.

Hard and inorganic fillers such as calcium carbonate (CaCO₃) are particularly suitable as fillers for the filled layers of the packaging film.

In addition to or as an alternative to CaCO₃, a metal oxide component can be used as a filler. Alkaline earth oxides are particularly advantageous as metal oxide components. Calcium oxide (CaO) has proven to be particularly advantageous, although the use of magnesium oxide is also conceivable.

Talc and/or calcium carbonate-magnesium carbonate have also proved particularly effective as fillers.

Preferably, the filler has a specific surface area of less than 12 m²/g, preferably less than 10 m²/g, in particular less than 8 m²/g and/or more than 2 m²/g, preferably more than 3 m²/g, in particular more than 4 m²/g. A filler with such a specific surface area is particularly suitable for creating cavities or vacuoles, which give the packaging film an overall density of less than 0.99 g/cm³ and a favorable opacity.

In a favorable variant of the invention, the average particle size of the filler in each filled layer is more than 0.5 μm, preferably more than 0.8 μm, in particular more than 1.2 μm and/or less than 8 μm, preferably less than 5 μm, in particular less than 3 μm. Filler particles with such an average particle size do not protrude from a filled layer.

The filler content can be determined using known measurement methods such as ashing. A sample with a known weight is heated to a temperature at which the polymer thermally decomposes but the filler does not. For example, 560° C. has proven to be a good temperature for this. The sample weight is then measured again. The polymer content per square meter can be calculated using the difference between the weighed out and weighed in weight.

As an alternative to ashing, a TGA measurement is possible in which the weight of a sample is measured continuously during heating. This test method can also clearly differentiate between polymer and filler and allows the polymer content of the film to be determined.

Ideally, the proportion of filler in each filled layer of the packaging film is more than 20% by weight, preferably more than 30% by weight, in particular more than 40% by weight and/or less than 80% by weight, preferably less than 70% by weight, in particular less than 60% by weight. The proportion of fillers is calculated in such a way that only microporous cavities are formed by stretching, which do not have a significant network of interconnections.

Mineral fillers reduce the amount of polymer in films such as packaging film and are therefore particularly sustainable. This also reduces CO₂ emissions during the production of the packaging film. Recycled polyethylene is also suitable as a polymer component of the packaging film, making it possible to produce a particularly sustainable packaging film.

Opacity is the opposite of transparency. It is a measure of opacity or opaqueness and is usually expressed as a percentage. In particular, the opacity of a completely opaque film is 100% and a completely or fully transparent film has an opacity of 0%.

Ideally, the packaging film has an opacity according to DIN 53416 of more than 65%, preferably more than 70%, in particular more than 80%. This means that the film can be printed directly and does not require an opaque layer under the print, which must first be created or applied.

In a particularly favorable variant of the invention, the proportion of titanium dioxide in the packaging film is less than 1% by weight, preferably less than 0.5% by weight, in particular less than 0.1% by weight. This means that the packaging film is practically free of titanium dioxide and thus does not contain any supposedly carcinogenic substance. At the same time, the use of at least one filled layer and the monoaxial stretching in the machine direction means that an ideal opacity of the packaging film can be achieved, which is favorable for printing.

The packaging film, which is practically free of titanium dioxide, therefore complies with the European chemicals regulation REACH and the amendment to the CLP regulation. The packaging film can therefore be described as free from harmful substances.

A packaging film for greasy foods, such as butter and cheese, should have a stable fold or fold resistance measured according to ASTM D920-49 over time in the warehouse, on sale and at the customer.

Ideally, the packaging film has a dead fold of more than 35%, preferably more than 45%, in particular more than 55% according to ASTM D920-49. Accordingly, the packaging film can advantageously guarantee the wrapped shape over the period from packaging to consumption of the food.

In order to keep butter and cheese fresh for a long time and also make the packaging film visually appealing, the polyolefin packaging film should have good grease resistance. The grease resistance of paper, coated paper or plastic films is tested using dyed palm kernel grease in accordance with DIN 53116. The sample is coated with the test grease on the test side and then placed on a glass plate and, if necessary, additional weights. After the exposure time has elapsed, the point-shaped grease passages up to 1 mm in size that are visible to the naked eye on the display paper within the defined test area are evaluated. If only grease passages up to 1.0 mm are observed, the test is considered to have been passed; for grease passages larger than 1.0 mm, the test must be carried out under milder test conditions.

Advantageously, the packaging film has a grease penetration according to DIN 53116 of less than 5, preferably less than 3, in particular less than 1 per 100 mm×100 mm. It can therefore be assumed that the packaging film is particularly suitable for packaging greasy foods. The film keeps the food fresh, does not let any grease through and looks attractive.

The water vapor permeability of dry or moisture-sensitive goods is determined in accordance with DIN 53116 using a gravimetric measurement method. A test container filled with a desiccant is sealed with a sample of packaging film and exposed to a defined test climate. The amount of water permeating through the sample is determined by weighing. A quantity of water in a range of 1-200 g/(m²−d) can be detected. The detection limit is also dependent on the composition and thickness of the sample.

Ideally, the packaging film has a water vapor transmission rate of less than 20 g/(m²−d), preferably less than 10 g/(m²−d), in particular less than 5 g/(m²−d) according to DIN 53122-1. The packaging film thus ensures minimal water vapor transmission and therefore a particularly long storage time for the greasy foods.

The gas transmission of plastic films is determined in accordance with ISO 15105 using the differential pressure method. A test specimen made of a packaging film separates two chambers, from which the gas transmission through a plastic film is measured by the difference in partial pressure on both sides of the film. This method makes it possible to quantitatively determine the gas transmission of a material.

Advantageously, the packaging film has an oxygen transmission rate of less than 10,000 cm³/m²d bar, preferably less than 5,000 cm³/m²d bar, in particular less than 2,000 cm³/m²d bar according to ISO 15105. The packaging film can therefore significantly reduce the influence of oxygen on the shelf life of greasy foods.

In a particularly advantageous variant of the invention, the blocking layer comprises a black pigment, wherein the packaging film has a radiation or light transmission according to DIN 10050-9 of less than 10%, preferably less than 7.5%, in particular less than 5%. The packaging film according to the invention provides excellent protection for a grease-containing foodstuff from being affected by radiation.

By introducing the black pigment into the blocking layer, the blocking layer can also be interpreted as a barrier layer against light or radiation.

For example, the packaging film has a light transmission of 1.5% in accordance with DIN 10050-9.

In an alternative variant of the invention, the functional layer may additionally or exclusively comprise a black pigment, wherein the packaging film has a radiation or light transmission according to DIN 10050-9 of less than 10%, preferably less than 7.5%, in particular less than 5%.

The flow behavior of polyolefins is described using the melt index MI (Melt Index) according to ISO 1133, usually at a temperature of 190° C. for polyethylene and 230° C. for polypropylene at a load of 2.16 or 5 kg. A higher melt index correlates with a lower average molecular weight of the polymer. At the same time, the higher the melt index of a polymer, the lower the melt viscosity, which is advantageous for good dispersion of the filler and a high output of the extrusion system. On the other hand, polymers with a high molecular weight, i.e. a low melt index, are advantageous in terms of mechanical stability, in particular tensile strength and toughness.

The functional layer of the packaging film is preferably made of at least 60% by weight HDPE whose density is more than 0.940 g/cm³, preferably more than 0.950 g/cm³ and/or less than 0.965 g/cm³, preferably less than 0.960 g/cm³ and/or whose melt flow index (at 190° C. at 2.16 kg) according to ISO 1133 is more than 0.1 g/10 min, preferably more than 0.2 g/10 min and/or less than 5.0 g/10 min, preferably less than 3.0 g/10 min. This results in a packaging film that is resistant to bending and has an excellent barrier against grease and excellent foldability.

For example, the functional layer of the packaging film is made of at least 65% by weight HDPE, preferably 70% by weight HDPE, in particular 80% by weight HDPE.

In addition, the functional layer may, by way of example, comprise more than 15% by weight, preferably more than 25% by weight, in particular more than 35% by weight of a polyolefin.

The blocking layer of the packaging film is preferably formed from a metallocene LLDPE whose density is more than 0.86 g/cm³, preferably more than 0.88 g/cm³ and/or less than 0.92 g/cm³, preferably less than 0.91 g/cm³ and/or whose melt flow index (at 190° C. at 2.16 kg) ISO 1133 is more than 0.1 g/10 min, preferably more than 0.2 g/10 min and/or less than 5.0 g/10 min, preferably less than 3.0 g/10 min. The blocking layer advantageously realizes a radiation impermeability and prevents the film from sticking together until the desired sealing, for example when laminating with another film or realized in the blocked version of the packaging film.

Flexographic printing is a frequently used process for printing packaging film. This is a direct letterpress process, also known as a fat-fed rotary printing process. The flexible printing plates, which are made of photopolymer or rubber, are used in combination with low-viscosity printing inks. The raised areas of the printing form are image-bearing. The advantages lie in the economic efficiency due to the utilization of a large printing width and a high printing speed, as well as the availability of cost-effective printing inks. The printing tools mainly consist of photopolymer printing plates and/or laser-engraved elastomer sleeves. Large print runs can be produced economically with flexographic printing.

A high opacity of the film is important for a high-quality print image on a polyolefin film. To achieve this, titanium dioxide is usually added to the composition before the film is extruded in order to achieve a high opacity of the film. In 2019, the European Commission decided to classify titanium dioxide powder as a suspected carcinogen in an amendment to the CLP Regulation. The use of titanium dioxide should therefore be reduced or better avoided.

In addition, polyolefin films should be particularly rigid for use in packaging films for greasy foods. However, the undesirable elasticity of the film causes a printability problem, as on the one hand the print definition can suffer and at the same time a high consumption of printing ink is required to achieve the highest possible quality print image.

In a particularly favorable variant of the invention, an imprint is arranged directly on a filled layer of the packaging film. The imprint can be designed as a print motif. In the field of packaging film, the term print motif refers to the thematic design part of an imprint. If necessary, manufacturer-identifying print motifs can also be included in the scope of the imprint.

For example, the overprint can also be designed as a primer. This can advantageously improve adhesion for further imprints.

Preferably, the imprint is applied to a filled layer of the packaging film using a flexographic printing process, whereby all conventional printing processes are in principle suitable for this purpose and are expressly included in the invention.

The proportion of fillers in the filled layers in combination with the monoaxial stretching in the machine direction creates a film that is particularly stiff in the xy direction and at the same time elastic in the z direction due to the fillers. As a result, the printed image can be applied more easily and adheres better with less ink consumption, especially compared to printed papers. This results in a high-resolution and sharp print image.

In an alternative variant of the invention, the filled layers of the packaging film can each have different proportions of filler. As a result, different volume fractions of cavities are formed in the filled layers due to different filler proportions.

Preferably, the outermost, filled layer, on which an imprint is directly arranged, would have a higher proportion of filler and thus a higher opacity.

In an advantageous embodiment, the polyolefinic film is used as packaging for butter and cheese. For this purpose, the thickness of the packaging film is less than 100 μm, preferably less than 85 μm, in particular less than 70 μm and/or more than 20 μm, preferably more than 35 μm, in particular more than 50 μm.

Ideally, the packaging film has a bending stiffness according to ISO 2493 of more than 100 mN/m, preferably more than 200 mN/m, in particular more than 300 mN/m. This makes the packaging film particularly dimensionally stable and rigid.

The tensile properties are determined in accordance with DIN EN ISO 527. In the tensile test, a test strip of a film is stretched at a constant speed specified in the test standard and the force F is recorded with the change in length ΔL of the measuring section L₀.

Advantageously, the packaging film has a tensile strength in the machine direction according to DIN EN ISO 527-3 of more than 30 MPa, preferably more than 60 MPa, in particular more than 100 MPa.

For example, the packaging film has a modulus of elasticity according to DIN EN ISO 527-3 in the machine direction and/or transverse to the machine direction of more than 500 MPa, preferably more than 800 MPa, in particular more than 1100 MPa and/or less than 2000 MPa, preferably less than 1900 MPa, in particular less than 1800 MPa.

In a particularly favorable variant of the invention, the polyolefin on which the entire packaging film is based is a polyethylene. Polyethylene (PE) is a thermoplastic produced by chain polymerization of petrochemically produced ethene. Polyethylene is semi-crystalline and non-polar.

Ideally, the polyolefin is exclusively polyethylene. This means that the food packaging meets the requirements of the European Union's Plastics Pact, is based on a mono-material construction and is recyclable.

According to the invention, the method of manufacturing a packaging film comprises several steps. First, various compositions of the polymer components are produced, which are then extruded to form a film with at least three layers. The polymer mixtures differ with respect to the filled layer and the unfilled functional layer as well as the blocking layer, wherein the polymer mixture of the filled layer comprises a filler for creating cavities. Advantageously, the film is stretched monoaxially in the machine direction, whereby the favorable properties in terms of overall density below 0.99 g/cm³, opacity and printability, grease and gas impermeability of the packaging film are achieved. The film can then be printed directly onto.

The properties of the blocking layer also functionalize this layer as a barrier layer, in particular as a barrier against light or radiation.

The packaging film is produced by monoaxial stretching with a machine direction orientation (MDO) by heating the packaging film to a temperature slightly below its melting point and stretching it in a specific orientation. Stretching can also take place directly after extrusion, where the film is still at a temperature slightly below its melting point.

Ideally, extrusion is carried out as blow extrusion, which favors the formation of advantageous film characteristics such as rigidity.

In an advantageous variant of the invention, the packaging film is stretched monoaxially in the machine direction by more than a factor of 2.0, preferably by more than a factor of 3.0, in particular by more than a factor of 4.0 and/or stretched by less than a factor of 7.0, preferably by less than a factor of 6.5, in particular by less than a factor of 6.0. This gives the packaging film an advantageous fold resistance and a favorable opacity and at the same time the density of the packaging film has a value of less than 0.99 g/cm³.

The packaging film is preferably also based on a monomaterial construction made of polyethylene. As a result, the packaging film according to the invention can be used as recyclable and unmixed printed packaging for grease-containing foodstuffs which, despite a high mineral content, has an overall density of less than 0.99 g/cm³ and can therefore float within a recycling process using the float-sink method. The packaging film fulfills the requirements of the European Union's Plastics Pact and is free of harmful substances in accordance with the amending regulation to the CLP regulation.

The packaging film according to the invention is significantly more sustainable and ecological than satinized paper and/or an aluminium composite film. In addition, the packaging film is also recyclable. Compared to satinized paper or an aluminium composite film, (environmental) costs are also saved in the production of packaging films due to lower energy consumption in the manufacturing process. At the same time, the packaging film has a significantly lower CO₂ footprint compared to satinized paper or aluminium composite film.

In one application, the packaging film can also be laminated with other films, for example to realize grease resistance, light impermeability and bending stiffness in a laminate.

### BRIEF DESCRIPTION OF THE DRAWINGS

Further advantages and features of the invention are apparent from the description of an embodiment example with reference to drawings and from the drawings themselves. It shows

FIG. 1 shows a schematic structure of the packaging film according to the invention,

FIG. 2 shows a schematic structure of the packaging film in a blocked version.

### DETAILED DESCRIPTION

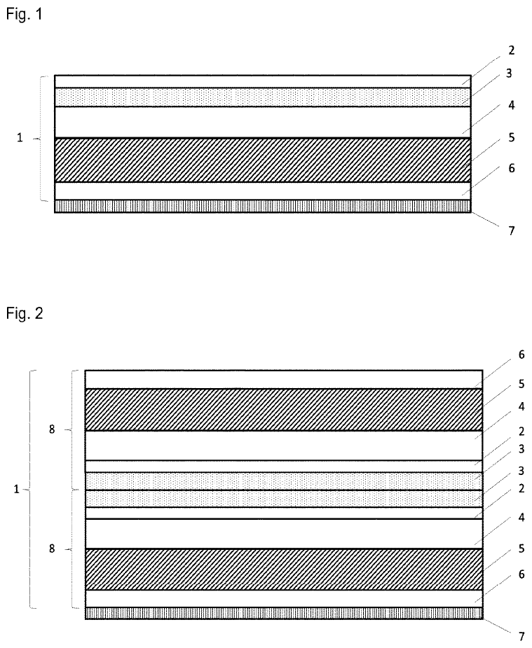

FIG. 1 shows a schematic structure of the packaging film 1. An imprint 7 is arranged on the packaging film 1. The imprint 7 comprises motifs that show, for example, greasy foods. In addition, identifying and informative imprints 7 are also conceivable. In addition, the visual recognition and image support of a brand image can also be incorporated into the imprint 7.

In the embodiment shown in FIG. 1, the packaging film 1 has a five-layer structure. The layers 2, 4 and 6 are designed as mineral-filled PE layers, whereby the proportion of CaCO₃ is approx. 50% by weight.

The unfilled functional layer 5 is arranged between the filled layers 4 and 6. The unfilled functional layer 5 is made of 60% by weight HDPE and 40% by weight COC polyethylene.

The density of the HDPE is 0.953 g/cm³ and its melt flow index (at 190° C. at 2.16 kg) according to ISO 1133 is 0.3 g/10 min. The unfilled functional layer 5 realizes the tough, tear-resistant and rigid properties of the packaging film 1. In addition, the functional layer 5 prevents the penetration of grease.

After blow extrusion, the packaging film 1 has a thickness of 300 μm. After monoaxial stretching by a factor of 5.0, the thickness of the packaging film is 60 μm.

The blocking layer 3 is made of a metallocene LLDPE with a density of 0.902 g/cm³ and a melt flow index (at 190° C. at 2.16 kg) of 1.0 g/10 min in accordance with ISO 1133. The blocking layer 3 realizes the radiation resistance of the packaging film 1.

The embodiment of the packaging film 1 shown in FIG. 2 essentially corresponds to the embodiment in FIG. 1. In this embodiment, the packaging film 1 is designed in a ten-layer structure consisting of two films 8, which are brought together in mirror image at the blocking layer 3. The blocking layer 3 is used here to block two identical films. For this purpose, the filled layer 2 is reversed in sequence with the blocking layer 3 and thus arranged between the blocking layer 3 and the filled layer 4. The packaging film is stretched monoaxially by a factor of 6.0 and has a thickness of 85 μm.

1. A polyolefinic packaging film (1) for grease-containing foodstuffs, the polyolefinic packaging film (1) comprising:
at least one blocking layer (3), a functional layer (5) and a filled layer (2, 4, 6),
the packaging film (1) being stretched to produce a proportion of cavities thereby reducing an overall density of the packaging film (1) to less than 0.99 g/cm³, to facilitate a recycling process.

2. The packaging film according to claim 1, wherein the overall density of the packaging film (1) is less than 0.97 g/cm³, and more than 0.70 g/cm³.

3. The packaging film according to claim 1, wherein the filled layer (2,4,6) has a volume fraction of cavities of more than 15% and of less than 60%.

4. The packaging film according to claim 1, wherein the packaging film (1) has a dead fold of more than 35% according to ASTM D920-49.

5. The packaging film according to claim 1, wherein the packaging film (1) has a grease penetration according to DIN 53116 of less than 5 per 100 mm×100 mm.

6. The packaging film according to claim 1, wherein the packaging film (1) has an opacity according to DIN 53416 of more than 65%.

7. The packaging film according to claim 1, wherein the packaging film (1) has a titanium dioxide content of less than 1% by weight.

8. The packaging film according to claim 1, wherein the packaging film (1) has a water vapour transmission rate of less than 20 g/(m²−d) according to DIN 53122-1.

9. The packaging film according to claim 1, wherein the packaging film (1) has an oxygen transmission rate of less than 10,000 cm³/m²d bar according to ISO 15105.

10. The packaging film according to claim 1, wherein the blocking layer (3) or the functional layer (5) comprises a black pigment, and the packaging film (1) having a light transmittance according to DIN 10050-9 of less than 10%.

11. The packaging film according to claim 1, wherein the functional layer (5) has an HDPE content of at least 60% by weight, the HDPE having a density of more than 0.945 g/cm³, and less than 0.965 g/cm³, and a melt flow rate (at 190° C. at 2.16 kg) according to ISO 1133 of more than 0.1 g/10 min, and less than 5.0 g/10 min.

12. The packaging film according to claim 1, wherein the blocking layer (3) comprises a metallocene LLDPE with a density of more than 0.86 g/cm³, and less than 0.92 g/cm³, and having a melt flow rate (at 190° C. at 2.16 kg) according to ISO 1133 of more than 0.1 g/10 min, and less than 5.0 g/10 min.

13. The packaging film according to claim 1, wherein the filled layer (2, 4, 6) comprises an inorganic carbonate as filler, wherein the filler has a specific surface area of less than 10 m²/g, and more than 2 m²/g.

14. The packaging film according to claim 1, wherein a proportion of filler in the filled layer (2, 4, 6) is more than 20% by weight, and less than 80% by weight.

15. The packaging film according to claim 1, wherein the packaging film (1) is stretched monoaxially in a machine direction by more than a factor of 3.0, and is stretched by less than a factor of 7.0.

16. The packaging film according to claim 1, wherein an imprint (7) is arranged directly on the filled layer (2, 6).

17. The packaging film according to claim 1, wherein characterized the packaging film (1) has a thickness of less than 100 μm, and more than 20 μm.

18. The packaging film according to claim 1, wherein the packaging film (1) has a bending stiffness according to ISO 2493 of more than 100 mN/m.

19. The packaging film according to claim 1, wherein the packaging film (1) has a tensile strength in a machine direction according to DIN EN ISO 527-3 of more than 30 MPa.

20. A method of manufacturing a packaging film (1) comprising the following steps:
producing various compositions,
extruding the compositions into a film,
stretching the film in the machine direction to form a packaging film (1), and
printing on the packaging film (1).

21. The method of claim 20, further comprising using the packaging film as recyclable packaging for grease-containing foodstuffs.
